(19) United States
(12) Patent Application Publication
(10) Pub. No.: US 2025/0200734 A1
(43) Pub. Date: Jun. 19, 2025

(54) QUANTIFICATION OF MICRO-SCALE BIOMASS, NECROMASS, ROOT ARCHITECTURE, PORE STRUCTURE, AND SEDIMENT DENSITY IN WETLAND SOILS USING X-RAY COMPUTED TOMOGRAPHY

(71) Applicant: Board of Supervisors of Louisiana State University and Agricultural and Mechanical College, Baton Rouge, LA (US)

(72) Inventors: Mohamed Hassan, Baton Rouge, LA (US); Navid H. Jafari, Baton Rouge, LA (US)

(21) Appl. No.: 18/982,189

(22) Filed: Dec. 16, 2024

Related U.S. Application Data
(60) Provisional application No. 63/610,163, filed on Dec. 14, 2023.

(51) Int. Cl. G06T 7/00; G06V 10/762; G06V 10/774; G06V 20/10

(52) U.S. Cl. CPC G06T 7/0002; G06V 10/762; G06V 10/774; G06V 20/188; G06T 2207/10072; G06T 2207/20081; G06T 2207/30188

(57) ABSTRACT

Various examples are provided related to root system analysis of a three-dimensional (3D) volume of a soil core sample. In one example, a method for root system analysis of a three-dimensional (3D) volume of a soil core sample includes normalizing image slices of an x-ray computed tomography (XCT) scan of the soil core sample and segmenting image slices of the XCT scan by clustering image features using Gaussian Mixture Model (GMM). The method further includes training a random forest (RF) model using the segmented image slices and in response to accuracy of the trained RF model satisfying a threshold condition, segmenting the 3D volume of the soil core sample using the trained RF model.

### CROSS REFERENCE TO RELATED APPLICATIONS

This application claims priority to, and benefit of, U.S. provisional application entitled “Quantification of Micro-Scale Biomass, Necromass, Root Architecture, Pore Structure, and Sediment Density in Wetland Soils Using X-Ray Computed Tomography” having Ser. No. 63/610,163 filed Dec. 14, 2023, which is hereby incorporated by reference in its entirety.

### STATEMENT REGARDING FEDERALLY SPONSORED RESEARCH OR DEVELOPMENT

This invention was made with government support under grant number 2202313 awarded by the National Science Foundation. The government has certain rights in the invention.

### BACKGROUND

To achieve sustainable and resilient coastal protection, nature-based solutions such as wetlands creation/rehabilitation are being promulgated by federal and local stakeholders. However, their capacity to withstand disturbance during a storm is largely dependent on how well wetland vegetation root structure can stabilize the intertidal platform. A better understanding of the root structure architecture and strength (RSAS) is needed to evaluate the marsh platform's ability to withstand surge and waves. For example, wetland testbeds can be examined to determine intertidal platform stability and long-term vulnerability to hurricanes, coastal erosion, and sea level rise (SLR) will affect these two distinct basins.

### SUMMARY

Aspects of the present disclosure are related to root system analysis. In one aspect, among others, a method for root system analysis of a three-dimensional (3D) volume of a soil core sample comprises normalizing image slices of an x-ray computed tomography (XCT) scan of the soil core sample; segmenting image slices of the XCT scan by clustering image features using Gaussian Mixture Model (GMM); training a random forest (RF) model using the segmented image slices; and in response to accuracy of the trained RF model satisfying a threshold condition, segmenting the 3D volume of the soil core sample using the trained RF model. In one or more of these aspects, the image features can comprise necromass, biomass, sediment, and pores. The image features can further comprise live roots, dead roots, and a combination of both. In some aspects, the RF model can be retrained if the accuracy of the trained RF model does not satisfy the threshold condition. In various aspects, normalizing the image slices can comprise a linear correction based upon at least one reference material. The at least one reference material can be high-density polyethylene (HDPE). In some aspects, normalizing the image slices can further comprise masking.

In another aspect, a system for root system analysis of a three-dimensional (3D) volume of a soil core sample comprises at least one computing device comprising processing circuitry, the at least one computing device configured to at least normalize image slices of an x-ray computed tomography (XCT) scan of the soil core sample; segment image slices of the XCT scan by clustering image features using Gaussian Mixture Model (GMM); train a random forest (RF) model using the segmented image slices; and, in response to accuracy of the trained RF model satisfying a threshold condition, segment the 3D volume of the soil core sample using the trained RF model. In one or more of these aspects, the image features can comprise necromass, biomass, sediment, and pores. In one or more of these aspects, the image features can comprise necromass, biomass, sediment, and pores. The image features can further comprise live roots, dead roots, and a combination of both. In some aspects, the RF model can be retrained if the accuracy of the trained RF model does not satisfy the threshold condition. In various aspects, normalizing the image slices can comprise a linear correction based upon at least one reference material. The at least one reference material can be high-density polyethylene (HDPE). In some aspects, normalizing the image slices can further comprise masking.

In another aspect, a non-transitory, computer-readable medium comprises machine-readable instructions for root system analysis of a three-dimensional (3D) volume of a soil core sample that, when executed by a processor of processing circuitry, cause the processing circuitry to at least normalize image slices of an x-ray computed tomography (XCT) scan of the soil core sample; segment image slices of the XCT scan by clustering image features using Gaussian Mixture Model (GMM); train a random forest (RF) model using the segmented image slices; and, in response to accuracy of the trained RF model satisfying a threshold condition, segment the 3D volume of the soil core sample using the trained RF model. In one or more of these aspects, the image features can comprise necromass, biomass, sediment, and pores. In one or more of these aspects, the image features can comprise necromass, biomass, sediment, and pores. The image features can further comprise live roots, dead roots, and a combination of both. In some aspects, the RF model can be retrained if the accuracy of the trained RF model does not satisfy the threshold condition. In various aspects, normalizing the image slices can comprise a linear correction based upon at least one reference material. The at least one reference material can be high-density polyethylene (HDPE). In some aspects, normalizing the image slices can further comprise masking.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a map indicating the field sites in Atchafalaya and Terrebonne basins, in accordance with various embodiments of the present disclosure.

FIG. 2 includes images illustrating examples of a biomass sampler and field measurements during sampling, in accordance with various embodiments of the present disclosure.

FIG. 3 illustrates an example of a segmented scan of a soil core sample with three cases of live roots, in accordance with various embodiments of the present disclosure.

FIG. 4 illustrates an example of an image processing workflow for the scan of a soil core sample, in accordance with various embodiments of the present disclosure.

FIG. 5 illustrates an example of preliminary quantification results of a soil core sample, in accordance with various embodiments of the present disclosure.

FIG. 6 is a flowchart illustrating an example of a root system analysis, in accordance with various embodiments of the present disclosure.

FIG. 7 is a schematic diagram illustrating an example of processing circuitry that can be used for implementing a root system analysis methodology, in accordance with various embodiments of the present disclosure.

### DETAILED DESCRIPTION

Disclosed herein are various examples related to root system analysis. X-Ray Computed Tomography (XCT) scanning can be used to quantify the micro-scale live biomass, necromass, root architecture, macro pore structure, and sediment density in cores collected from terrestrial or wetland soils, such as the Atchafalaya and Terrebonne Basins across a salinity gradient of fresh to saline marsh. The use of XCT to quantify roots, rhizomes, and peat offers a precise replacement for time-consuming, and highly variable traditional hand-sieving methods. Reference will now be made in detail to the description of the embodiments as illustrated in the drawings, wherein like reference numbers indicate like parts throughout the several views.

### Field Campaign

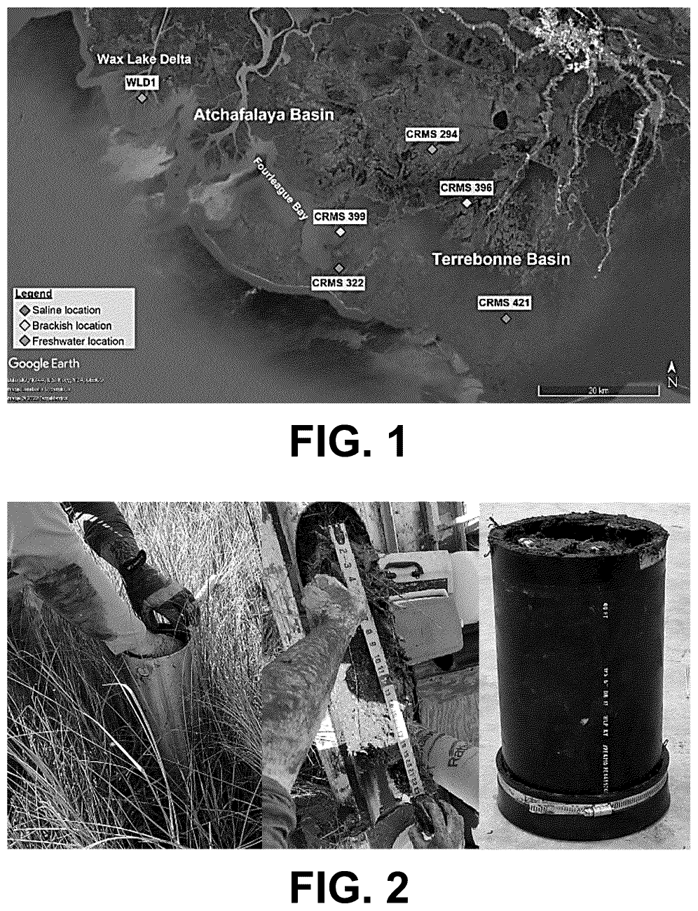

XCT imaging was used to quantify the micro-scale live biomass, necromass, root architecture, macro pore structure, and sediment density in cores collected from the Atchafalaya and Terrebonne Basins across a salinity gradient of fresh to saline marsh. Fieldwork campaigns to collect soil samples were the first step of the research methodology. FIG. 1 shows a map indicating the field sites in Atchafalaya and Terrebonne basins. Fieldwork included sampling and conducting cone penetration testing (CPTu). Samples were collected using a biomass core sampler. The soil cores were obtained using a metal corer with a 15 cm diameter and 40 cm length. Following sampling, the soil cores were extruded into 35-cm-long, 15-cm-diameter HDPE pipes. FIG. 2 includes images of the biomass sampler and field measurements during sampling. The samples were sent to the Pacific Northwest National Lab (PNNL) Environmental Molecular Sciences Lab (EMSL) in Richland, Washington for scanning.

### Image Processing

X-ray Computed Tomography (XCT) scans provide a unique window into the intricate world of belowground root systems, offering invaluable insights for various scientific disciplines. However, the analysis of XCT scans is a challenging endeavor due to the complexities of these images, including overlapping grayscale values of pores, live and dead roots, and sediment. To overcome these challenges and extract meaningful information, a sophisticated and highly effective XCT scan segmentation methodology was developed. The use of XCT to quantify roots, rhizomes, and peat offers an accurate alternative to the traditional hand-sieving methods that are time-consuming and prone to high variability. The XCT scan analysis involves image segmentation performed using Fiji, supplemented with Matlab and Python to initially segment scans and quantify live roots volume. Segmentation of XCT scans is a challenging task because of the overlap in grey values of roots, pores and sediment. In addition to the classical image processing, scans were segmented using machine learning (unsupervised and supervised) models. Gaussian Mixture Model (GMM), which is a probabilistic machine learning algorithm, can be used to segment scans by implementing the expectation-maximization (EM) algorithm for fitting mixture of Gaussian models. Moreover, it is possible to use ML-analysis tools and/or virtual reality software (e.g., Avizo, VG Studio Max, SyGlass).

XCT slices analysis included three steps: normalization, segmentation and quantification. Image normalization ensures optimal comparisons across data acquisition methods and texture instances. The normalization of pixel values (intensity) is recommended for imaging modalities that do not correspond to absolute physical quantities. In this work, a linear correction was performed to establish baseline pixel intensities along the core for two reference materials: (1) high-density polyethylene (HDPE) pipe, and (2) air located between the sample and scanning domain. This step is important for calibrating the scans and ensuring consistent results.

Afterwards, a masking process is employed to isolate the regions of interest within the XCT scans, with a specific focus on areas containing root systems. Image segmentation in digital image processing is used for dividing the image into different segments and discrete regions. Image segmentation is a challenging, complex task that is affected by numerous aspects, including noise, low contrast, illumination, and irregularity of the object boundaries. The outcome of image segmentation is a group of segments that jointly enclose the whole image or a collection of contours taken out from the image. By focusing the analysis to these regions, X-Roots reduces noise and increases the efficiency of the subsequent segmentation. Although the correction of raw pixel intensities is one of the cornerstone elements of this methodology, the heart of methodology-Roots lies in the application of the Gaussian Mixture Model (GMM), a powerful machine learning algorithm.

In this work, an unsupervised machine learning algorithm was used to cluster data based on the Expectation Maximization. Gaussian mixture models (GMM) assume all the data points are generated from a mixture of a finite number of Gaussian distributions with unknown parameters. The GMM was applied using the python open-source library scikit-learn to segment a number of 2D scans along the core. The GMM leverages the probability distribution to effectively differentiate between the four components present in the scans. By modeling the data distribution, it can distinguish pores, dead roots, live roots, and other elements like sediments within the scans. This step serves as the basis of the segmentation process, providing precise information about root systems. The GMM can be used to segment randomly selected scans through the XCT volume which will be used as ground truth for a Random Forest (RF) model.

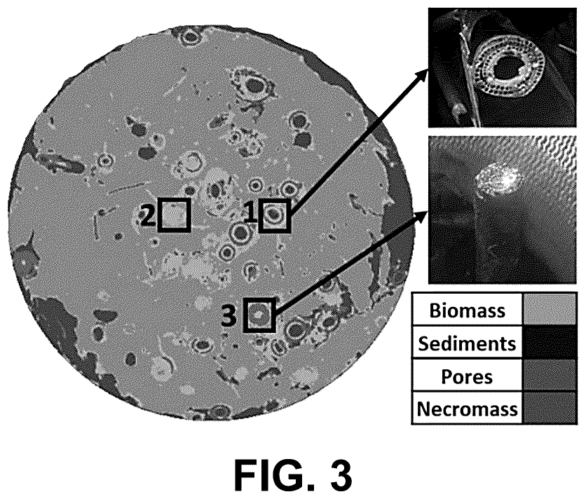

As the GMM is an unsupervised model, there is no direct influence over its output. This autonomy facilitates discovery of not only defined live roots and dead roots, but also roots in the state of decaying (i.e., characterized by both dead and live segments) as illustrated in FIG. 3. A segmented scan of Terrebonne Basin with three cases of live roots identified and examples of plant stems that visualize the roots are shown. Interestingly, this finding closely mirrors real-time images of plant stems where live roots could exhibit as: (1) concentric circles of live roots with dead segments in between and a pore at the core; (2) a completely filled live root; and (3) a live root at the circumference and a core with dead segment in-between. This discovery is unprecedented in the field of root system analysis, as most segmentation methods depend on human-generated ground truth images, which can be prone to high variability and subjectivity that affect the results. The ability to identify live, dead, and decaying roots represents a significant advancement in the understanding of root systems and how this affects wetland health and resilience, especially against natural hazards such as hurricanes.

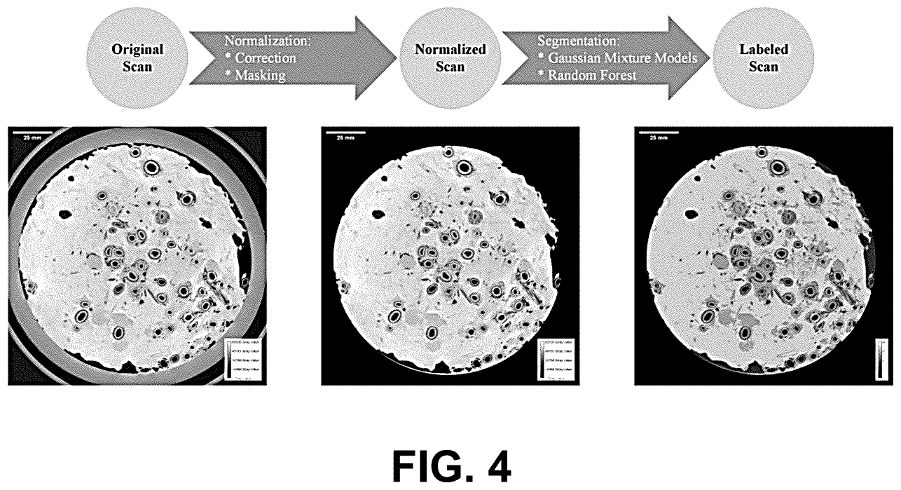

Afterwards, the GMM output (labeled image) can be used to train a random forest model using the same library (scikit-learn) along with various features (e.g., canny edge, gaussian s7, median s3, gabor) to segment the 3D volume. FIG. 4 illustrates the image processing workflow as well as an example of the original and segmented scan. This scan represents depth (10-15 cm) for site 421, Terrebonne. Segmented scans can be used in the quantification step and for studying the live biomass structure architecture.

The RF model was trained on a comprehensive set of features extracted from the XCT scans, encompassing various aspects of the images. These features include pixel values, which capture the raw intensity information of the scans, Canny Edge detection to track edges and boundaries, Gaussian filters (s3 and s7) to reduce noise and highlight relevant details, Median filters (s3) for noise removal, and gradient-based techniques such as Prewitt, Roberts, Scharr, and Sobel, which identify and emphasize gradient edges and features. The process also incorporates neighborhood variance analysis (Variance s3) to highlight edges in the image by replacing each pixel with the local variance. Additionally, X-Roots utilizes Gabor filters, a set of 32 combination filters used for texture analysis. These filters enable the detection of specific frequency content in the image, particularly in localized regions around points or areas of interest. After training the RF model, it was deployed to segment the entire 3D volume of image stacks. X-Roots implemented parallelization techniques using Python to optimize this process, ensuring efficiency and time-saving. FIG. 4 graphically illustrates the XCT image analysis methodology describing the area of interest and the ML models used.

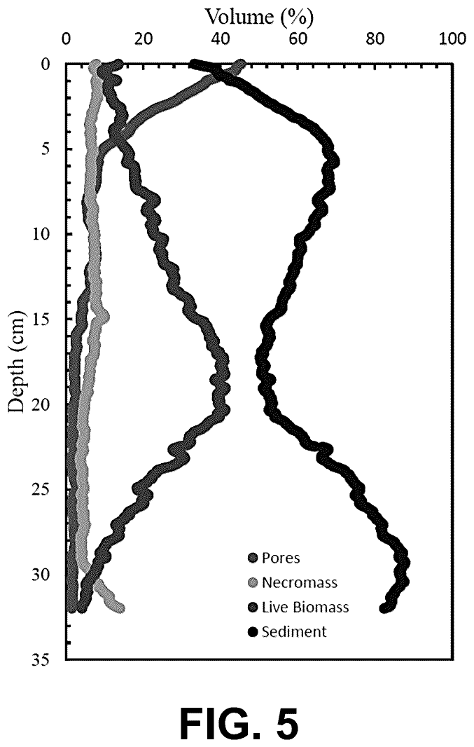

Quantifying the micro-scale biomass, necromass, root architecture, macro-pores, and sediment density using XCT scans is important to understanding the capacity of the intertidal platform to withstand hurricane disturbance and the role of root structure architecture and strength (RSAS) to the ecosystem design of more resilient natural features. The labelled scans allow biomass (live roots) and necromass (dead roots) quantification by counting each labeled index in each slice of the scans and then multiplying this count by the voxel size, resulting in the volume of each element within the specific slice. This process can be repeated across the entire volume of the scans to obtain the total live and dead roots within the XCT volume. In this work, the area occupied by each label was calculated for each scan along the entire core. FIG. 5 illustrates an example of the preliminary quantification results of the biomass, necromass, macro-pores, and sediment volume with depth for site 421, Terrebonne.

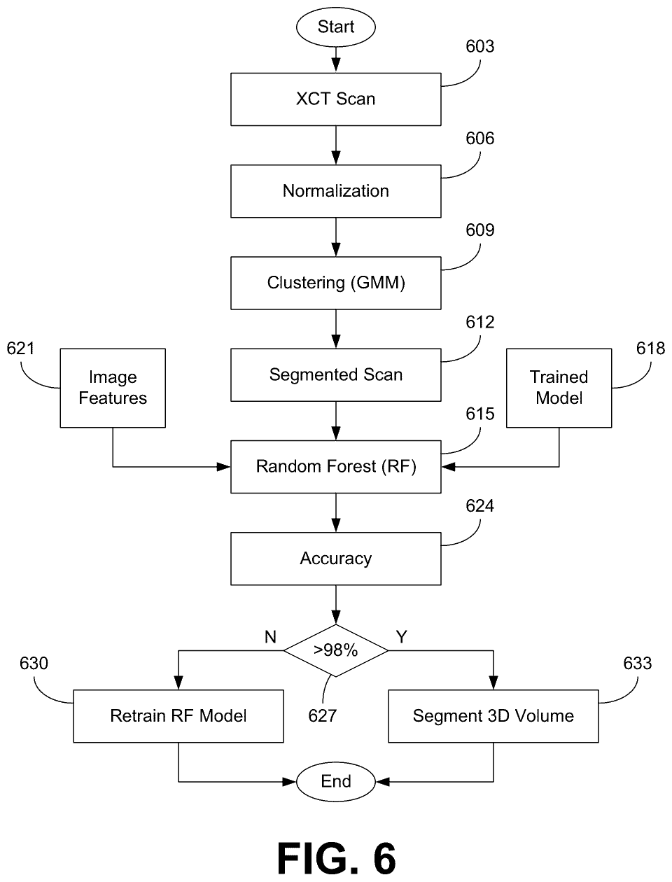

FIG. 6 illustrates an example of a root system analysis methodology that can be carried out on XCT scans of, e.g., wetland soil core samples obtained as previously discussed. Beginning at 603, a XCT scan of a soil core sample can be obtained for analysis of the root systems. Normalization of the XCT slices can be carried out at 606 utilizing, e.g., correction and masking. Clustering can then be carried out at 609 using, e.g., Gaussian mixture models (GMMs) to classify the data into different clusters (e.g., macropores, necromass, live roots, sediment) based on probability distributions with the segmented scan provided at 612. At 615, the segmented scan is applied to the random forest (RF) model. The trained RF model 618 is trained on a comprehensive set of image features 621 extracted from the XCT scans, encompassing various aspects of the images. The accuracy of the trained RF model is evaluated at 624 and if it does not meet or exceed a defined threshold (e.g., 98%) at 627, then the RF model is retrained at 630. If the accuracy condition is satisfied at 627, then the RF model is deployed to segment the entire 3D volume of the XCT scan.

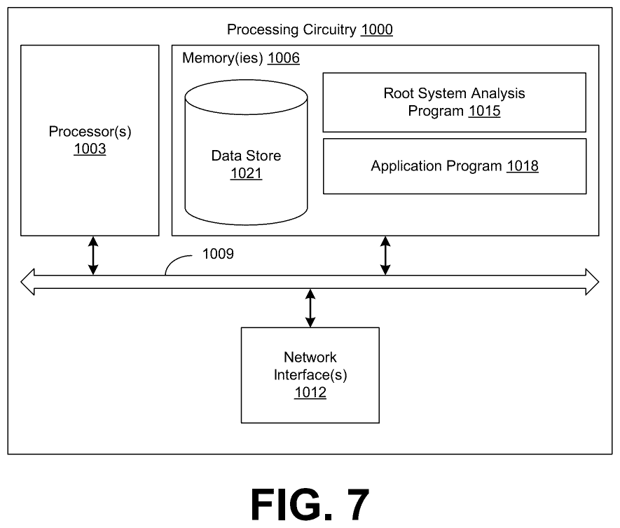

FIG. 7 is a schematic diagram illustrating an example of processing circuitry 1000 that can be used for the disclosed root system analysis methodology, in accordance with various embodiments of the present disclosure. The processing circuitry 1000 can comprise one or more computing/processing device such as, e.g., a computer, controller, smartphone, tablet, etc. The processing circuitry 1000 can include at least one processor circuit (e.g., a microcontroller circuit), for example, having a processor 1003 and a memory 1006, both of which are coupled to a local interface 1009. To this end, each processing circuitry 1000 may comprise, for example, at least one server computer or like device, which can be utilized in a cloud-based environment. The local interface 1009 may comprise, for example, a data bus with an accompanying address/control bus or other bus structure as can be appreciated.

In some embodiments, the processing circuitry 1000 can include one or more network interfaces 1012. The network interface 1012 may comprise, for example, a wireless transmitter, a wireless transceiver, and/or a wireless receiver. The network interface 1012 can communicate to a remote computing/processing device or other components using a Bluetooth, WiFi, or other appropriate wireless protocol. As one skilled in the art can appreciate, other wireless protocols may be used in the various embodiments of the present disclosure. The network interface 1012 can also be configured for communications through wired connections.

Stored in the memory 1006 are both data and several components that are executable by the processor(s) 1003. In particular, stored in the memory 1006 and executable by the processor 1003 can be a root system analysis application 1015 which can provide real-time fault diagnosis to detect and identify the location of a fault in a power electronics system as disclosed herein, and potentially other applications 1018. In this respect, the term “executable” means a program file that is in a form that can ultimately be run by the processor(s) 1003. Also stored in the memory 1006 may be a data store 1021 and other data. In addition, an operating system may be stored in the memory 1006 and executable by the processor(s) 1003. It is understood that there may be other applications that are stored in the memory 1006 and are executable by the processor(s) 1003 as can be appreciated.

Examples of executable programs may be, for example, a compiled program that can be translated into machine code in a format that can be loaded into a random access portion of the memory 1006 and run by the processor(s) 1003, source code that may be expressed in proper format such as object code that is capable of being loaded into a random access portion of the memory 1006 and executed by the processor(s) 1003, or source code that may be interpreted by another executable program to generate instructions in a random access portion of the memory 1006 to be executed by the processor(s) 1003, etc. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores, and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, ultrasound or other devices. The processor 1003 may be of electrical or of some other available construction.

Although the root system analysis application 1015, and other various applications 1018 described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the root system analysis application 1015, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the root system analysis application 1015, may be implemented and structured in a variety of ways. For example, one or more applications described may be implemented as modules or components of a single application. For example, the root system analysis application 1015 can include a wide range of modules such as, e.g., an initial model or other modules that can provide specific functionality for the disclosed methodology. Further, one or more applications described herein may be executed in shared or separate computing/processing devices or a combination thereof. For example, a plurality of the applications described herein may execute in the same processing circuitry 1000, or in multiple computing/processing devices in the same computing environment. To this end, each processing circuitry 1000 may comprise, for example, at least one server computer or

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for root system analysis of a three-dimensional (3D) volume of a soil core sample, comprising:
normalizing image slices of an x-ray computed tomography (XCT) scan of the soil core sample;
segmenting image slices of the XCT scan by clustering image features using Gaussian Mixture Model (GMM);
training a random forest (RF) model using the segmented image slices; and
in response to accuracy of the trained RF model satisfying a threshold condition, segmenting the 3D volume of the soil core sample using the trained RF model.

2. The method of claim 1, wherein the image features comprise necromass, biomass, sediment, and pores.

3. The method of claim 2, wherein the image features further comprise live roots, dead roots, and a combination of both.

4. The method of claim 1, wherein the RF model is retrained if the accuracy of the trained RF model does not satisfy the threshold condition.

5. The method of claim 1, wherein normalizing the image slices comprises a linear correction based upon at least one reference material.

6. The method of claim 5, wherein the at least one reference material is high-density polyethylene (HDPE).

7. The method of claim 5, wherein normalizing the image slices further comprises masking.

8. A system for root system analysis of a three-dimensional (3D) volume of a soil core sample, comprising:
at least one computing device comprising processing circuitry, the at least one computing device configured to at least:
normalize image slices of an x-ray computed tomography (XCT) scan of the soil core sample;
segment image slices of the XCT scan by clustering image features using Gaussian Mixture Model (GMM);
train a random forest (RF) model using the segmented image slices; and
in response to accuracy of the trained RF model satisfying a threshold condition, segment the 3D volume of the soil core sample using the trained RF model.

9. The system of claim 8, wherein the image features comprise necromass, biomass, sediment, and pores.

10. The system of claim 9, wherein the image features further comprise live roots, dead roots, and a combination of both.

11. The system of claim 8, wherein the RF model is retrained if the accuracy of the trained RF model does not satisfy the threshold condition.

12. The system of claim 8, wherein normalizing the image slices comprises a linear correction based upon at least one reference material.

13. The system of claim 12, wherein the at least one reference material is high-density polyethylene (HDPE).

14. The system of claim 12, wherein normalizing the image slices further comprises masking.

15. A non-transitory, computer-readable medium, comprising machine-readable instructions for root system analysis of a three-dimensional (3D) volume of a soil core sample that, when executed by a processor of processing circuitry, cause the processing circuitry to at least:
normalize image slices of an x-ray computed tomography (XCT) scan of the soil core sample;
segment image slices of the XCT scan by clustering image features using Gaussian Mixture Model (GMM);
train a random forest (RF) model using the segmented image slices; and
in response to accuracy of the trained RF model satisfying a threshold condition, segment the 3D volume of the soil core sample using the trained RF model.

16. The non-transitory, computer-readable medium of claim 15, wherein the image features comprise necromass, biomass, sediment, and pores.

17. The non-transitory, computer-readable medium of claim 16, wherein the image features further comprise live roots, dead roots, and a combination of both.

18. The non-transitory, computer-readable medium of claim 15, wherein normalizing the image slices comprises a linear correction based upon at least one reference material.

19. The non-transitory, computer-readable medium of claim 18, wherein the at least one reference material is high-density polyethylene (HDPE).

20. The non-transitory, computer-readable medium of claim 18, wherein normalizing the image slices further comprises masking.
